(19) United States
(12) Patent Application Publication
(10) Pub. No.: US 2015/0013488 A1
(43) Pub. Date: Jan. 15, 2015

(54) ELECTRIC VEHICLE POWER TRANSMISSION APPARATUS

(71) Applicant: EXEDY Corporation, Neyagawa-shi, Osaka (JP)

(72) Inventors: Yoshihiro Matsuoka, Neyagawa-shi (JP); Kenji Kitada, Neyagawa-shi (JP)

(21) Appl. No.: 14/380,001

(22) PCT Filed: Apr. 15, 2013
(86) PCT No.: PCT/JP2013/061196

§ 371 Date: Aug. 20, 2014

(30) Foreign Application Priority Data
Apr. 17, 2012 (JP) 2012-093465

(51) Int. Cl. F16H 1/20; B60K 1/00; F16D 7/00

(52) U.S. Cl. CPC F16H 1/20; F16D 7/00; B60K 1/00
USPC 74/405

(57) ABSTRACT

A power transmission device is embedded in an electric vehicle equipped with an electric motor and a transmission. The transmission includes a first reduction mechanism and a second reduction mechanism. The power transmission device also includes a spline hub coupled to an output side of the first reduction mechanism, a clutch plate coupled to an input side of the second reduction mechanism, and a coupling portion. The coupling portion is disposed between the spline hub and the clutch plate, and includes a damper mechanism configured to absorb a vibration from the spline hub and transmit a torque to the clutch plate, and a torque limiter configured to transmit the torque and to limit transmission of the torque when the torque is greater than or equal to a predetermined magnitude.

### CROSS-REFERENCE TO RELATED APPLICATIONS

This application is a U.S. National stage application of International Application No. PCT/JP2013/061196, filed Apr. 15, 2013, which claims priority to Japanese Patent Application No. 2012-093465, filed in Japan on Apr. 17, 2012, the entire contents of which are hereby incorporated by reference.

### BACKGROUND

1. Field of Invention

The present invention relates to a power transmission device, particularly to a power transmission device that is configured to transmit a driving force and is embedded in an electric vehicle including an electric motor and a transmission into which a rotation from the electric motor is inputted.

2. Background Information

Electric vehicles, using an electric motor as a power source, have been produced in recent years. Further, this type of vehicle is also provided with a transmission for obtaining an optimal torque characteristic in accordance with a variety of travelling conditions.

For example, Japanese Utility Model Application Publication

No. JP-U-S59-172853 describes a two stage transmission including an input shaft, an output shaft, a planetary gear unit, a cone clutch, a one-way clutch and a control unit.

On the other hand, Japanese Laid-open Patent Application Publication No. JP-A-H06-249302 describes a gear transmission for an electric vehicle, which includes a gear drive train for starting and a gear drive train for high speed.

### SUMMARY

An electric vehicle vibrates less than a vehicle using an engine as a drive source. However, cogging occurs in an electric motor. Cogging is a phenomenon in which a magnetic attraction force, generated between an armature and a rotor, minutely pulsates depending on a rotational angle. Such a phenomenon not only affects comfortableness in riding but also becomes a cause of reducing durability of components.

Further, in general, unlike an engine-driven vehicle, the electric vehicle does not need a starting clutch due to the characteristic of the electric motor. Hence, components are mechanically direct-coupled from the electric motor to drive wheels. In the structure, the components composing the drive train may be damaged when an excessive torque, generated in the electric motor or the drive wheels, is transmitted thereto.

It is an object of the present invention to inhibit occurrence of cogging attributed to an electric motor or prevent damage of respective components of a drive train attributed to transmission of an excessive torque in an electric vehicle.

A power transmission device for an electric vehicle according to a first aspect of the present invention is a device that is configured to transmit a driving force and is embedded in the electric vehicle equipped with an electric motor and a transmission into which a rotation from the electric motor is inputted. The power transmission device includes an input portion coupled to an output shaft of the electric motor, an output portion disposed between the input portion and the transmission, and a coupling portion. The coupling portion is disposed between the input portion and the output portion, and includes at least either of a damper mechanism configured to absorb a vibration from the input portion and transmit a torque to the output portion, and a torque limiter that is configured to transmit the torque and is configured to limit transmission of the torque when the torque is greater than or equal to a predetermined magnitude.

A power transmission device for an electric vehicle according to a second aspect of the present invention is a device that is configured to transmit a driving force and is embedded in the electric vehicle equipped with an electric motor and a transmission. The transmission includes a first reduction mechanism configured to decelerate a rotation from the electric motor and transmit the decelerated rotation, a second reduction mechanism configured to further decelerate the rotation from the first reduction mechanism and transmit the further decelerated rotation, and an output mechanism configured to transmit the rotation from the second reduction mechanism to a drive wheel. Further, the power transmission device includes an input portion coupled to an output side of the first reduction mechanism, an output portion coupled to an input side of the second reduction mechanism, and a coupling portion. The coupling portion is disposed between the input portion and the output portion, and includes at least either of a damper mechanism configured to absorb a vibration from the input portion and transmit a torque to the output portion, and a torque limiter that is configured to transmit the torque and is configured to limit transmission of the torque when the torque is greater than or equal to a predetermined magnitude.

A power transmission device for an electric vehicle according to a third aspect of the present invention relates to the device of the second aspect. The transmission includes a first shaft into which the rotation from the electric motor is inputted, an input gear configured to be rotated in synchronization with the first shaft, a second shaft disposed in parallel to the first shaft, a reduction gear that is configured to be rotated in synchronization with the second shaft and is meshed with the input gear, an intermediate gear rotatably disposed on the second shaft, and an output gear that is coupled to the output mechanism and is meshed with the intermediate gear. Further, the input portion is coupled to the second shaft, whereas the output portion is fixed to the intermediate gear.

A power transmission device for an electric vehicle according to a fourth aspect of the present invention relates to the device of the third aspect. The reduction gear is mounted to one end part of the second shaft. The intermediate gear is disposed adjacently to the reduction gear. The input portion is mounted to the other end part of the second shaft while being disposed on a side away from the reduction gear with respect to the intermediate gear.

A power transmission device for an electric vehicle according to a fifth aspect of the present invention relates to the device of the third aspect. The reduction gear is mounted to one end part of the second shaft. The intermediate gear is rotatably supported by the other end part of the second shaft. The input portion is disposed adjacently to the reduction gear.

A power transmission device for an electric vehicle according to a sixth aspect of the present invention is a device that is configured to transmit a driving force and is embedded in the electric vehicle equipped with an electric motor and a transmission. The transmission includes a first reduction mechanism configured to decelerate a rotation from the electric motor and transmit the decelerated rotation, a second reduction mechanism configured to further decelerate the rotation from the first reduction mechanism and transmit the further decelerated rotation, and an output mechanism configured to transmit the rotation from the second reduction mechanism to a drive wheel. Further, the power transmission device includes an input portion into which the rotation from the second reduction mechanism is inputted and that is rotatably supported by the output mechanism, an output portion coupled to the output mechanism, and a coupling portion. The coupling portion is disposed between the input portion and the output portion, and includes at least either of a damper mechanism configured to absorb a vibration from the input portion and transmit a torque to the output portion, and a torque limiter that is configured to transmit the torque and is configured to limit transmission of the torque when the torque is greater than or equal to a predetermined magnitude.

As described above, in the present invention, at least either of the damper mechanism and the torque limiter is provided in the drive train disposed between the electric motor and the drive wheel. Therefore, where the damper mechanism is provided, the occurrence of cogging can be inhibited. Where the torque limiter is provided, damage of respective components attributed to an excessive torque transmitted thereto can be prevented.

### BRIEF DESCRIPTION OF THE DRAWINGS

FIG. 1 is a cross-sectional structural view of a drive system for an electric vehicle including a power transmission device according to a first exemplary embodiment of the present invention.

FIG. 2 is a partial enlarged view of the first exemplary embodiment.

FIG. 3 is a cross-sectional structural view of a drive system for an electric vehicle including a power transmission device according to a second exemplary embodiment of the present invention.

FIG. 4 is a cross-sectional structural view of a drive system for an electric vehicle including a power transmission device according to a third exemplary embodiment of the present invention.

FIG. 5 is a cross-sectional structural view of a drive system for an electric vehicle including a power transmission device according to a fourth exemplary embodiment of the present invention.

### DESCRIPTION OF EXEMPLARY EMBODIMENTS

### First Exemplary Embodiment

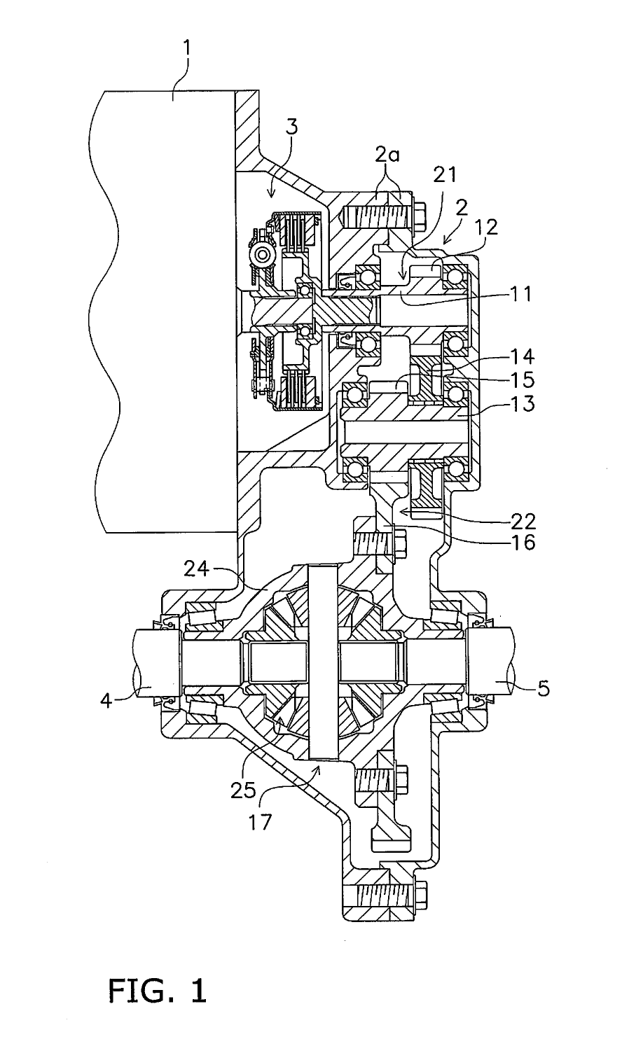

FIG. 1 illustrates a drive system for an electric vehicle including a power transmission device according to a first exemplary embodiment of the present invention. The drive system includes an electric motor 1 and a transmission 2. Further, a power transmission device 3 is disposed between the electric motor 1 and the transmission 2. In the drive system, a rotation of the electric motor 1 is configured to be decelerated by the transmission 2, and the decelerated rotation is configured to be transmitted to right and left axles 5 and 4. Wheels (not illustrated in the drawings) are coupled to the right and left axles 5 and 4.

The transmission 2 includes an input shaft 11, an input gear 12, an intermediate shaft 13, a reduction gear 14, an intermediate gear 15, an output gear 16 and a differential device 17. Further, the input gear 12 and the reduction gear 14 compose a first reduction mechanism 21, whereas the intermediate shaft 13, the intermediate gear 15 and the output gear 16 compose a second reduction mechanism 22.

The input shaft 11 is formed in a tubular shape; and both ends thereof are rotatably supported by a housing 2a of the transmission 2 through a pair of bearings. The input shaft 11 has a spline hole formed on a motor-side part of the inner peripheral surface thereof. The input gear 12 is integrally formed with the input shaft 11.

The intermediate shaft 13 is formed in a tubular shape, and both ends thereof are rotatably supported by the housing 2a of the transmission 2 through a pair of bearings.

The reduction gear 14 and the intermediate gear 15 are disposed to be rotated in synchronization with the intermediate shaft 13. Specifically, the reduction gear 14 is spline-coupled to the intermediate shaft 13, whereas the intermediate gear 15 is disposed on the outer peripheral part of the intermediate shaft 13 while being integrally formed with the intermediate shaft 13. The reduction gear 14 is meshed with the input gear 12. The intermediate gear 15 is meshed with the output gear 16.

The differential device 17 includes a case 24 and a differential gear mechanism 25 accommodated inside the case 24. The output gear 16 is fixed to the case 24. Further, the right and left axles 5 and 4 are coupled to the differential gear mechanism 25.

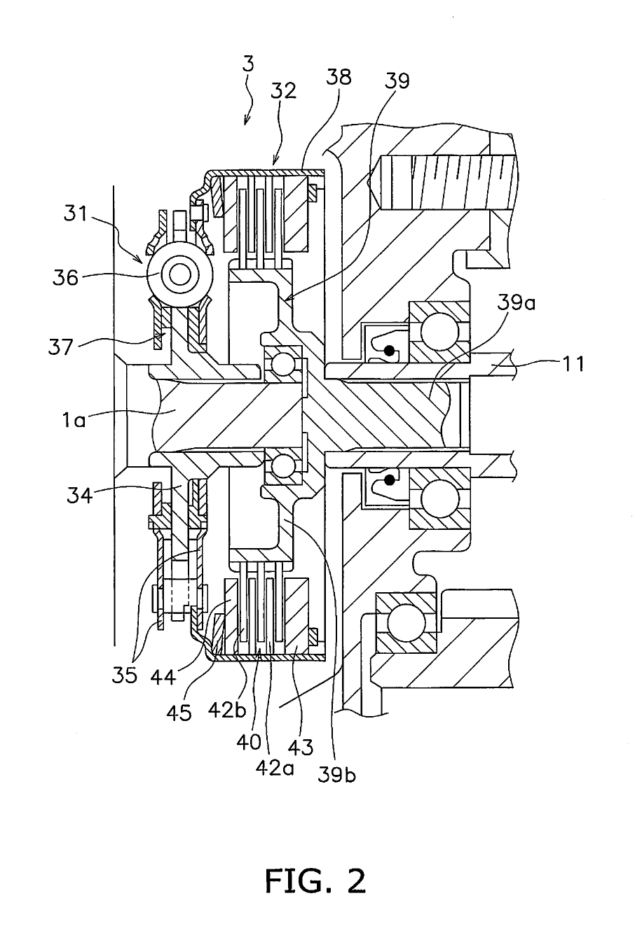

FIG. 2 illustrates an enlarged view of the power transmission device 3. The power transmission device 3 includes a damper mechanism 31 and a torque limiter 32.

The damper mechanism 31 has a heretofore known structure and includes a spline hub 34 as an input portion, a pair of plates 35 disposed on both sides of the flange of the spline hub 34, and a plurality of torsion springs 36 elastically coupling the spline hub 34 and the pair of plates 35 in a rotational direction. It should be noted that a hysteresis torque generating mechanism 37 for absorbing vibrations is disposed between the spline hub 34 and the pair of plates 35.

The torque limiter 32 includes a tubular case 38, a coupling member 39 as an output portion, and a torque limiting portion 40 disposed between the case 38 and the coupling member 39.

The motor-side end of the tubular case 38 is bent to the inner peripheral side, and the bent part is coupled to one of the pair of plates 35 of the damper mechanism 31.

The coupling member 39 is rotatably supported by an output shaft la of a motor 1 through a bearing. The coupling member 39 has a shaft part 39a and a flange part 39b formed on the tip end of the shaft part 39a. The shaft part 39a has a spline shaft formed on the outer periphery thereof, and the spline shaft is spline-coupled to the spline hole of the input shaft 11 of the transmission 2.

The torque limiting portion 40 includes a plurality of clutch plates 42a and 42b, a backing plate 43, a pressure plate 44 and a cone spring 45. Regarding the plural clutch plates 42a and 42b, the drive-side plates 42a are engaged with the case 38, whereas the driven-side plates 42b are engaged with the flange part 39b of the coupling member 39. The cone spring 45 is set in a compressed state between the pressure plate 44 and the bent part of the case 38. Accordingly, when a torque, which is greater than or equal to a torque set by a pressing load of the cone spring 45 and the clutch plates 42a and 42b, is inputted into the torque limiting portion 40, the torque limiting portion 40 is configured to slip and the torque is not transmitted to either the transmission-2 side or the motor side.

In the device as described above, the rotation of the motor 1 is configured to be transmitted to the transmission 2 through the damper mechanism 31 and the torque limiter 32. In the transmission 2, the rotation of the motor 1 is configured to be decelerated by the first reduction mechanism 21 and the second reduction mechanism 22, and the decelerated rotation is configured to be inputted into the differential device 17. In the differential device 17, a torque is distributed and transmitted to the respective axles 4 and 5 in accordance with loads acting on respective drive wheels.

In the drive system of the first exemplary embodiment, the power transmission device 3, including the damper mechanism 31 and the torque limiter 32, is disposed between the motor 1 and the transmission 2.

Hence, occurrence of cogging of the motor 1 can be inhibited, and damage of respective components can be prevented by limiting excessive torque transmission to the respective components. Further, the power transmission device 3 is disposed in the input part of the drive system. Hence, a torque to be transmitted becomes relatively small, and the capacity of the torque limiter 32 can be reduced. Yet further, due to a reason similar to the above, the damper mechanism 31 can be compactly formed.

### Second Exemplary embodiment

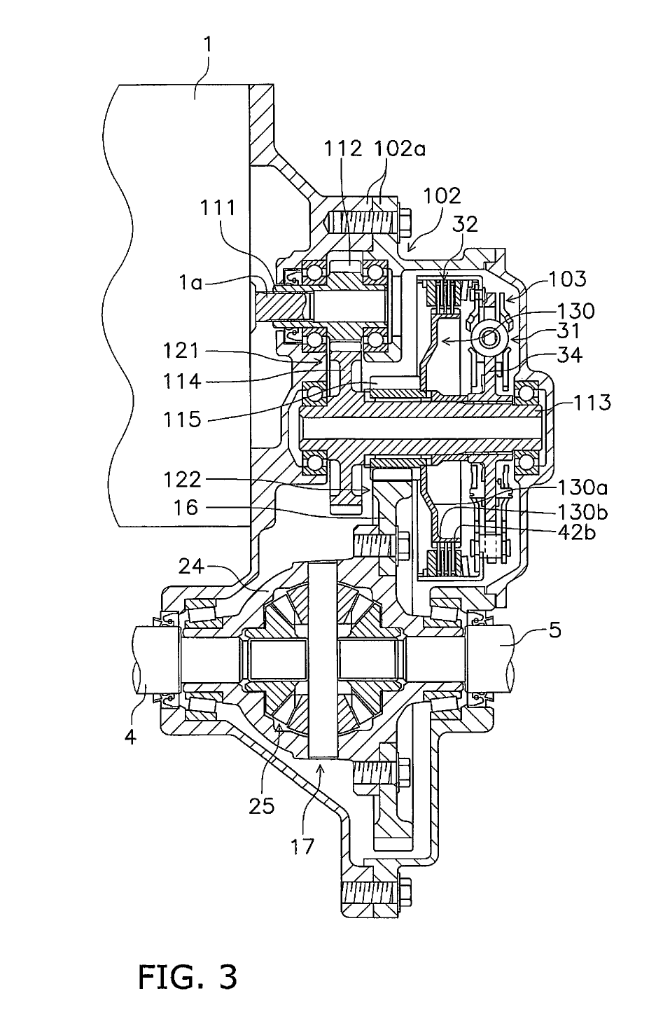

FIG. 3 illustrates a drive system to which a power transmission device 103 according to a second exemplary embodiment of the present invention is applied. The drive system includes the electric motor 1 and a transmission 102. Further, the power transmission device 103 is disposed inside the transmission 102. In the drive system, the rotation of the electric motor 1 is configured to be decelerated by the transmission 102, and the decelerated rotation is configured to be transmitted to the right and left axles 5 and 4. In the second exemplary embodiment, the same reference signs are assigned to elements similar to those in the first exemplary embodiment, and explanation will not be made for the elements similar to those in the first exemplary embodiment.

The transmission 102 includes an input shaft 111, an input gear 112, an intermediate shaft 113, a reduction gear 114, an intermediate gear 115, the output gear 16 and the differential device 17. The input gear 112 and the reduction gear 114 compose a first reduction mechanism 121, whereas the intermediate shaft 113, the intermediate gear 115 and the output gear 16 compose a second reduction mechanism 122.

The input shaft 111 is formed in a tubular shape, and both ends thereof are rotatably supported by a housing 102a of the transmission 102 through a pair of bearings. The inner peripheral part of the input shaft 111 and the output shaft la of the motor 1 are spline-coupled. The input gear 112 is disposed on the outer peripheral part of the input shaft 111, while being integrally formed with the input shaft 111.

The intermediate shaft 113 is formed in a tubular shape, and both ends thereof are rotatably supported by the housing 102a of the transmission 102 through a pair of bearings.

The reduction gear 114 is disposed on one end part of the intermediate shaft 113, while being integrally formed with the intermediate shaft 113. The intermediate gear 115 is disposed laterally adjacent to the reduction gear 114. The intermediate gear 115 is supported by the intermediate shaft 113, while being rotatable relatively thereto. The reduction gear 114 is meshed with the input gear 112. The intermediate gear 115 is meshed with the output gear 16.

The power transmission device 103 is disposed on the opposite side of the reduction gear 114 with respect to the intermediate gear 115. The power transmission device 103 has a basic structure similar to that in the first exemplary embodiment, and includes the damper mechanism 31 and the torque limiter 32.

The spline hub 34 of the damper mechanism 31 is spline-coupled to the intermediate shaft 113.

Further, the output side (the driven-side plates 42b included in the plural clutch plates) of the torque limiter 32 is engaged with a flange 130 fixed to the lateral surface of the intermediate gear 15. The flange 130 has a disc-shaped main body 130a having an aperture in the center part thereof, and a tubular part 130b formed on an end of the outer periphery of the main body 130a to axially extend therefrom.

The inner peripheral part of the main body 130a is fixed to the lateral surface of the intermediate gear 115. Further, the tubular part 130b has a plurality of teeth formed on the outer periphery thereof, and the teeth are engaged with the inner peripheral parts of the driven-side plates 42b included in the plural clutch plates.

In the device as described above, the rotation of the motor 1 is configured to be decelerated by the first reduction mechanism 121 of the transmission 102, and the decelerated rotation is configured to be inputted into the damper mechanism 31 of the power transmission device 103. Further, the rotation is transmitted to the second reduction mechanism 122 through the torque limiter 32, and is further inputted into the differential device 17. In the differential device 17, a torque is distributed and transmitted to the respective axles 4 and 5 in accordance with loads acting on the respective drive wheels .

Similar to the first exemplary embodiment, the drive system of the second exemplary embodiment can inhibit occurrence of cogging of the motor 1, and can prevent damage of the respective components by limiting excessive torque transmission to the respective components. Further, the power transmission device 103 is mounted onto the intermediate shaft 113 to which the rotation decelerated by the first reduction mechanism 121 is transmitted. Hence, a torque to be transmitted becomes large, but the rotation speed becomes relatively low. Thus, strengths of the respective components can be lowered, and cost reduction and weight reduction are enabled. In an electric vehicle, the rotation speed of the motor 1 tends to be higher than the rotation speed of the engine. Therefore, the second exemplary embodiment is especially effective in that the rotation speed of the power transmission device 103 becomes low.

### Third Exemplary Embodiment

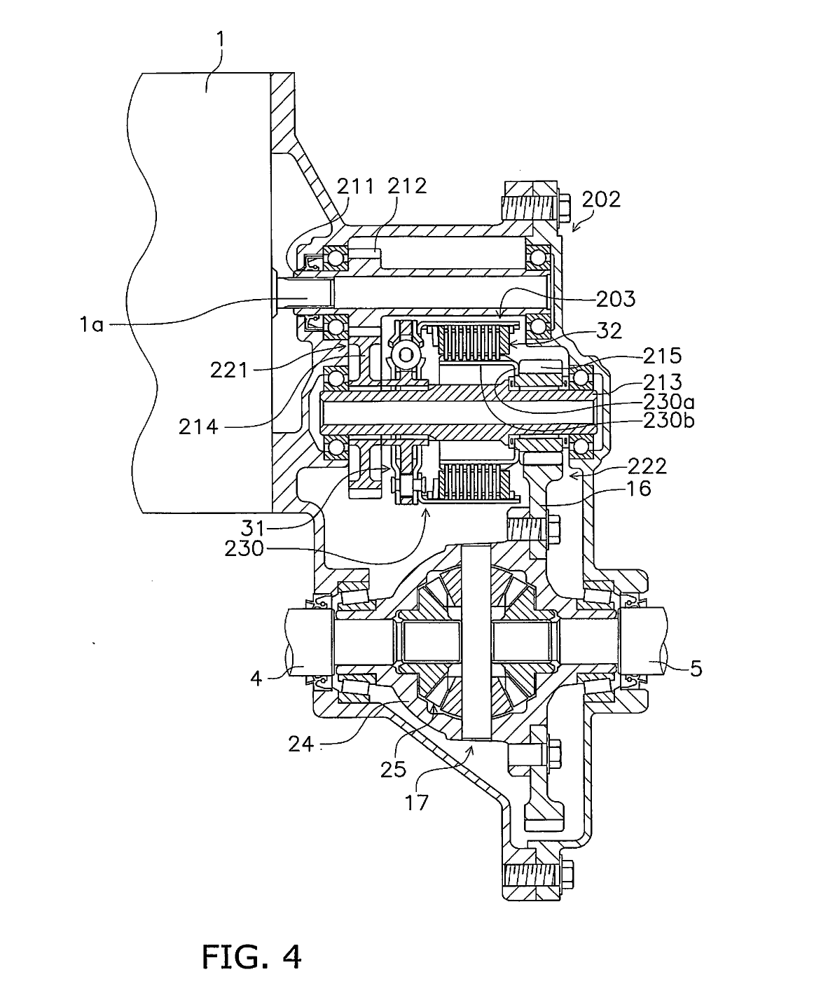

FIG. 4 illustrates a drive system to which a power transmission device 203 according to a third exemplary embodiment of the present invention is applied. The drive system includes the electric motor 1 and a transmission 202. Further, the power transmission device 203 is disposed inside the transmission 202. In the drive system, the rotation of the electric motor 1 is configured to be decelerated by the transmission 202, and the decelerated rotation is configured to be transmitted to the right and left axles 5 and 4.

In the third exemplary embodiment, the same reference signs are assigned to elements similar to those in the first and second exemplary embodiments, and explanation will not be made for the elements similar to those in the first and second exemplary embodiments.

The transmission 202 includes an input shaft 211, an input gear 212, an intermediate shaft 213, a reduction gear 214, an intermediate gear 215, the output gear 16 and the differential device 17. The input gear 212 and the reduction gear 214 compose a first reduction mechanism 221, whereas the intermediate shaft 213, the intermediate gear 215 and the output gear 16 compose a second reduction mechanism 222.

The specific shapes of the respective members in the third exemplary embodiment are different from those of the corresponding members in the second exemplary embodiment. However, the other structures in the third exemplary embodiment are basically the same as those in the second exemplary embodiment, although the arrangement of the power transmission device 203 in the third exemplary embodiment is only different from that of the power transmission device in the second exemplary embodiment.

In short, in the third exemplary embodiment, the reduction gear 214 and the intermediate gear 215 are disposed on both ends of the intermediate shaft 213, while the power transmission device 203 is disposed between these gears 214 and 215.

The power transmission device 203 has a structure similar to that in the aforementioned respective exemplary embodiments, and includes the damper mechanism 31 and the torque limiter 32. A path for transmitting power is configured similarly to that in the second exemplary embodiment. Power is inputted from the intermediate shaft 213 to the spline hub of the damper mechanism 31, and is then outputted from the output portion (the driven-side plates) of the torque limiter 32 to a tubular member 230 fixed to the intermediate gear 215. The tubular member 230 has a fixation part 230a fixed to a reduction gear 214 side lateral surface of the intermediate gear 215, and a tubular engaging part 230b axially extending from the outer periphery of the fixation part 230a. Further, the tubular engaging part 230b has a plurality of teeth formed on the outer periphery thereof, and the teeth are engaged with the inner peripheries of the driven-side clutch plates of the torque limiter 32.

The power transmission path of the aforementioned device is similar to that in the second exemplary embodiment. Specifically, the rotation of the motor 1 is configured to be decelerated by the first reduction mechanism 221 of the transmission 202, and the decelerated rotation is configured to be inputted into the damper mechanism 31 of the power transmission device 203. Further, the rotation is configured to be transmitted to the second reduction mechanism 222 through the torque limiter 32, and is further inputted into the differential device 17. In the differential device 17, a torque is distributed and transmitted to the respective axles 4 and 5 in accordance with loads acting on the respective drive wheels.

The drive system of the third exemplary embodiment can also achieve advantages effects similar to those achieved by the drive system of the second exemplary embodiment. In short, occurrence of cogging of the motor 1 can be inhibited, while damage of the respective components can be prevented by limiting excessive torque transmission to the respective components. Further, the rotation speed of the power transmission device 203 becomes low. Thus, the component strengths of the respective components can be lowered, and cost reduction and weight reduction are enabled.

### Fourth Exemplary Embodiment

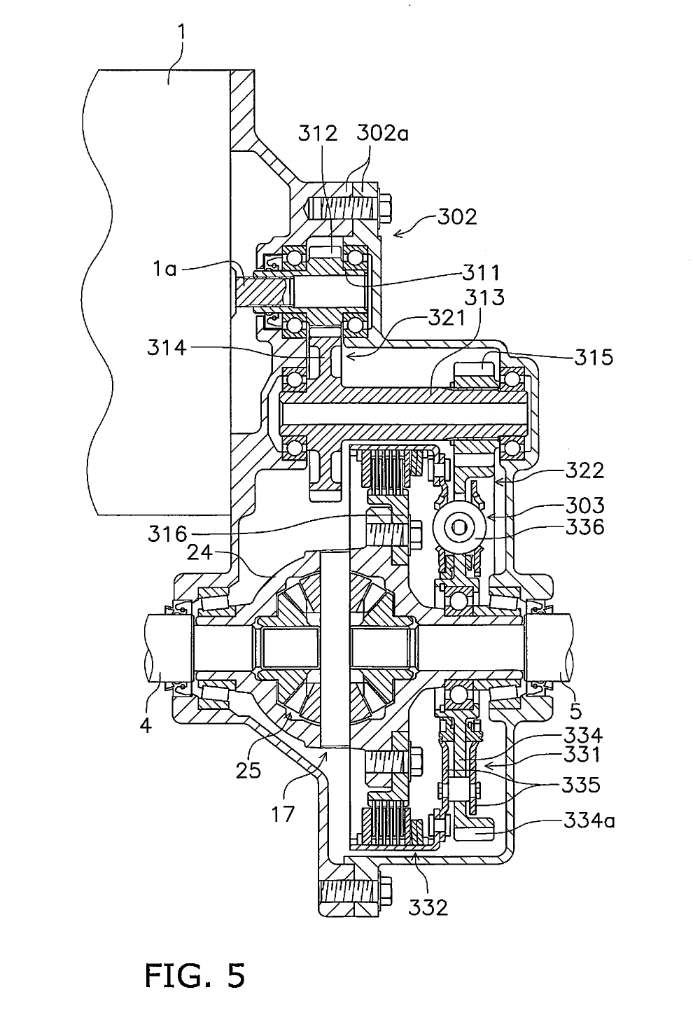

FIG. 5 illustrates a drive system to which a power transmission device 303 according to a fourth exemplary embodiment of the present invention is applied. The drive system includes the electric motor 1 and a transmission 302. Further, the power transmission device 303 is disposed inside the transmission 302. In the drive system, the rotation of the electric motor 1 is configured to be decelerated by the transmission 302, and the decelerated rotation is configured to be transmitted to the right and left axles 5 and 4. In the fourth exemplary embodiment, the same reference signs are assigned to elements similar to those in the aforementioned respective exemplary embodiments, and explanation will not be made for the elements similar to those in the aforementioned respective exemplary embodiments.

The transmission 302 includes an input shaft 311, an input gear 312, an intermediate shaft 313, a reduction gear 314, an intermediate gear 315, an output gear 316 and the differential device 17. The input gear 312 and the reduction gear 314 compose a first reduction mechanism 321, whereas the intermediate shaft 313, the intermediate gear 315 and a part of the power transmission device 303 compose a second reduction mechanism 322.

The input shaft 311 is formed in a tubular shape, and both ends thereof are rotatably supported by a housing 302a of the transmission 302 through a pair of bearings. The inner peripheral part of the input shaft 311 and the output shaft la of the motor 1 are spline-coupled. The input gear 312 and the input shaft 311 are integrally formed.

The intermediate shaft 313 is formed in a tubular shape, and both ends thereof are rotatably supported by the housing 302a of the transmission 302 through a pair of bearings. The reduction gear 314 is disposed on one end part of the intermediate shaft 313, while being integrally formed with the intermediate shaft 313. The reduction gear 314 is meshed with the input gear 312. The intermediate gear 315 is disposed on the other end part of the intermediate shaft 313. The intermediate gear 315 is spline-coupled to the intermediate shaft 313.

The power transmission device 303 includes a damper mechanism 331 and a torque limiter 332.

The damper mechanism 331 includes a spline hub 334 as an input portion, a pair of plates 335 disposed on the both sides of the flange of the spline hub 334, and a plurality of torsion springs 336 elastically coupling the spline hub 334 and the pair of plates 335 in the rotational direction.

The inner peripheral part of the spline hub 334 is rotatably supported by the case 24 of the differential device 17 through a bearing. Further, the spline hub 334 has a hub gear 334a on the outer peripheral part thereof, and the hub gear 334a is meshed with the intermediate gear 315.

It should be noted that a hysteresis torque generating mechanism for absorbing vibrations is disposed between the spline hub 334 and the pair of the plates 335.

The torque limiter 332 has a structure similar to the structures of the torque limiters in the respective exemplary embodiments. The torque limiter 332 includes a tubular case, a torque limiting portion having a plurality of clutch plates, and so forth. Further, the driven-side plates included in the plural clutch plates are meshed with the output gear 316 fixed to the case of the differential device 17.

In the device as described above, the rotation of the motor 1 is configured to be decelerated by the first reduction mechanism 321 of the transmission 302, and the decelerated rotation is configured to be inputted into the damper mechanism 331 of the power transmission device 303 through the intermediate gear 315 and the hub gear 334a.

Further, the rotation is configured to be inputted into the output gear 316 and the differential device 17 through the torque limiter 332. In the differential device 17, a torque is distributed and transmitted to the respective axles 4 and 5 in accordance with loads acting on the respective drive wheels.

Similarly to the drive systems of the aforementioned respective exemplary embodiments, the drive system of the fourth exemplary embodiment can inhibit occurrence of cogging of the motor 1, and can prevent damage of the respective components by limiting excessive torque transmission to the respective components. Further, the power transmission device 303 is herein disposed downstream of the first and second reduction mechanism 321 and 322 in the power transmission flow. Therefore, the rotation speed of the power transmission device 303 becomes low. Thus, the component strengths of the respective components can be lowered, and cost reduction and weight reduction are enabled. Other Exemplary Embodiment

The present invention is not limited to the exemplary embodiments as described above, and a variety of changes or modifications can be made without departing from the scope of the present invention.

In the power transmission device of the present invention, at least either of the damper mechanism and the torque limiter is disposed in the drive train disposed between the electric motor and the drive wheels. Therefore, where the damper mechanism is provided, it is possible to inhibit occurrence of cogging. Where the torque limiter is provided, it is possible to prevent damage of respective components attributed to an excessive torque transmitted thereto.

1. A power transmission device for an electric vehicle, the power transmission device being configured to transmit a driving force, the power transmission device being embedded in the electric vehicle equipped with an electric motor and a transmission into which a rotation from the electric motor is inputted, the power transmission device comprising:
an input portion coupled to an output shaft of the electric motor;
an output portion disposed between the input portion and the transmission; and
a coupling portion disposed between the input portion and the output portion, the coupling portion including at either one of a damper mechanism and a torque limiter, the damper mechanism being configured to absorb a vibration from the input portion and transmit a torque to the output portion, the torque limiter being configured to transmit the torque and being configured to limit transmission of the torque when the torque is greater than or equal to a predetermined magnitude.

2. A power transmission device for an electric vehicle, the power transmission device being configured to transmit a driving force, the power transmission device being embedded in the electric vehicle equipped with an electric motor and a transmission including a first reduction mechanism, a second reduction mechanism and an output mechanism, the first reduction mechanism being configured to decelerate a rotation from the electric motor and transmit the decelerated rotation, the second reduction mechanism being configured to further decelerate the rotation from the first reduction mechanism and transmit the further decelerated rotation, the output mechanism being configured to transmit the rotation from the second reduction mechanism to a drive wheel, the power transmission device comprising:
an input portion coupled to an output side of the first reduction mechanism;
an output portion coupled to an input side of the second reduction mechanism; and
a coupling portion disposed between the input portion and the output portion, the coupling portion including at least one of a damper mechanism and a torque limiter, the damper mechanism being configured to absorb a vibration from the input portion and transmit a torque to the output portion, the torque limiter being configured to transmit the torque and being configured to limit transmission of the torque when the torque is greater than or equal to a predetermined magnitude.

3. The power transmission device for an electric vehicle recited in claim 2, wherein
the transmission includes
a first shaft into which the rotation from the electric motor is inputted;
an input gear configured to be rotated in synchronization with the first shaft;
a second shaft being disposed in parallel to the first shaft;
a reduction gear configured to be rotated in synchronization with the second shaft, the reduction gear being meshed with the input gear;
an intermediate gear rotatably disposed on the second shaft; and
an output gear coupled to the output mechanism, the output gear being meshed with the intermediate gear,
the input portion being coupled to the second shaft, and
the output portion being fixed to the intermediate gear.

4. The power transmission device for an electric vehicle recited in claim 3, wherein
the reduction gear is mounted to one end part of the second shaft,
the intermediate gear is disposed adjacently to the reduction gear, and
the input portion is mounted to the other end part of the second shaft while being disposed on a side away from the reduction gear with respect to the intermediate gear.

5. The power transmission device for an electric vehicle recited in claim 3, wherein
the reduction gear is mounted to one end part of the second shaft,
the intermediate gear is rotatably supported by the other end part of the second shaft, and
the input portion is disposed adjacently to the reduction gear.

6. A power transmission device for an electric vehicle, the power transmission device being configured to transmit a driving force, the power transmission device being embedded in the electric vehicle equipped with an electric motor and a transmission including a first reduction mechanism, a second reduction mechanism and an output mechanism, the first reduction mechanism being configured to decelerate a rotation from the electric motor and transmit the decelerated rotation, the second reduction mechanism being configured to further decelerate the rotation from the first reduction mechanism and transmit the further decelerated rotation, the output mechanism being configured to transmit the rotation from the second reduction mechanism to a drive wheel, the power transmission device comprising:
an input portion into which the rotation from the second reduction mechanism is inputted, the input portion being rotatably supported by the output mechanism,
an output portion coupled to the output mechanism, and
a coupling portion disposed between the input portion and the output portion, the coupling portion including at least one of a damper mechanism and a torque limiter, the damper mechanism being configured to absorb a vibration from the input portion and transmit a torque to the output portion, the torque limiter being configured to transmit the torque and being configured to limit transmission of the torque when the torque is greater than or equal to a predetermined magnitude.
